(19) United States
(12) Patent Application Publication
(10) Pub. No.: US 2008/0304476 A1
(43) Pub. Date: Dec. 11, 2008

(54) ETHERNET OVER MPLS CIRCUIT EMULATION SERVICE

(75) Inventors: Shafiq Pirbhai, Kanata (CA); Francois L. Bouchard, Ottawa (CA); Robin Jeffrey Park, Kanata (CA); Neil Hart, Chelsea (CA)

Correspondence Address: MARKS & CLERK, P.O. BOX 957, STATION B, OTTAWA, ON, K1P 5S7, CA

(73) Assignee: ALCATEL LUCENT, Paris (FR)

(21) Appl. No.: 11/760,355

(22) Filed: Jun. 8, 2007

(51) Int. Cl. H04L 12/66

(52) U.S. Cl. 370/356

(57) ABSTRACT

A method and apparatus are provided for providing CES using both Ethernet and MPLS networks. TDM data is packetized and Ethernet encapsulated, and then MPLS encapsulated. Following insertion into an MPLS core network, the packet is routed to a destination MPLS router using MPLS routing. The MPLS encapsulation is then removed, and the resulting Ethernet frame inserted into a destination Ethernet network. The Ethernet frame is routed to a destination Ethernet port using Ethernet routing. The TDM data is extracted, and inserted into the appropriate TDM channel. The invention allows inexpensive Ethernet equipment to be used at the boundary with the TDM network, and a reliable MPLS network with its QoS functionality to be used for any long-haul part of the CES.

### FIELD OF THE INVENTION

The invention relates to circuit emulation service, and more particularly to deployment of circuit emulation service over both Ethernet and MPLS networks.

### BACKGROUND OF THE INVENTION

Circuit Emulation Service (CES) is a fast growing area in telecommunications. Carriers can realize cost savings by moving TDM circuits (such as used for carrying traditional voice traffic) onto CES over a packet switched network. Typical deployments are CES on Ethernet because of the low cost of Ethernet interfaces and networks. See for example “MEF8: Implementation Agreement for the Emulation of PDH Circuits over Metro Ethernet Networks”, Metro Ethernet Forum, 2004, which is incorporated herein by reference. However, Ethernet does not provide the reliability and Quality of Service guarantees that are provided by other services such as ATM and MPLS. Reliability and QoS guarantees can be important in ensuring that requirements of the traffic (e.g. delay-sensitivity of voice traffic) can be met, especially when a carrier is trying to fully utilize the capacity of its network. In addition, carriers typically do not employ Ethernet for long-haul traffic.

CES can alternatively be carried directly on ATM, MPLS, and IP services, as described for example in Vainshtein (ed.), “Structure-aware TDM Circuit Emulation Service over Packet Switched Network (CESoPSN)”, draft-ietf-pwe3-cesopsn-07.txt, IETF, 2006 and which is incorporated herein by reference. While such an implementation provides better reliability and QoS guarantees, doing so does not take advantage of the low cost of Ethernet interfaces and switches.

### SUMMARY OF THE INVENTION

In accordance with one aspect of the invention, a method is provided for providing circuit emulation service. TDM data is packetized. The packetized TDM data is encapsulated with Ethernet encapsulation. The packetized and Ethernet-encapsulated TDM data is transmitted to a destination Ethernet network over an Ethernet pseudo-wire through an MPLS network. Within the destination Ethernet network, the TDM data is extracted from the packetized and encapsulated TDM data, and the extracted TDM data is transmitted onto a TDM channel. Transmitting the packetized and Ethernet-encapsulated TDM data over an Ethernet pseudo-wire may be carried out by encapsulating the packetized and Ethernet-encapsulated TDM data with MPLS encapsulation, and conveying the packetized and Ethernet- and MPLS-encapsulated TDM data to a destination MPLS router through a tunnel defined by the MPLS encapsulation.

In accordance with another aspect of the invention, a method is provided for preparing a packet for CES. TDM data is received and packetized. The packetized TDM data is encapsulated with Ethernet encapsulation such that a destination Ethernet switch and destination TDM channel are specified. The packetized and Ethernet-encapsulated TDM data is encapsulated with MPLS encapsulation such that a destination MPLS router and an Ethernet port on the destination MPLS router are specified.

Apparatus are provided for carrying out the methods of the invention. The methods of the invention may be stored as processing instructions on computer-readable media.

The methods and apparatus of the present invention make use of Ethernet in the access network and MPLS in the core network. This provides the low-cost advantages of Ethernet, while also providing the advantages of reliability and QoS guarantees of an MPLS network. The invention is particularly advantageous for high volume cost and delay sensitive applications, such as voice traffic. Use of the combination of Ethernet and MPLS for providing CES also allows a carrier to use Ethernet in a metro area and have some SONET infrastructure for long-haul traffic.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a network in which CES is provided according to one embodiment of the invention;

FIG. 2 is a diagram of the format of the packet generated and transmitted by the MPLS router of FIG. 1 according to one embodiment of the invention; and

FIG. 3 is a diagram of a network in which CES is provided according to another embodiment of the invention.

It will be noted that in the attached figures, like features bear similar labels.

### DETAILED DESCRIPTION OF THE EMBODIMENTS

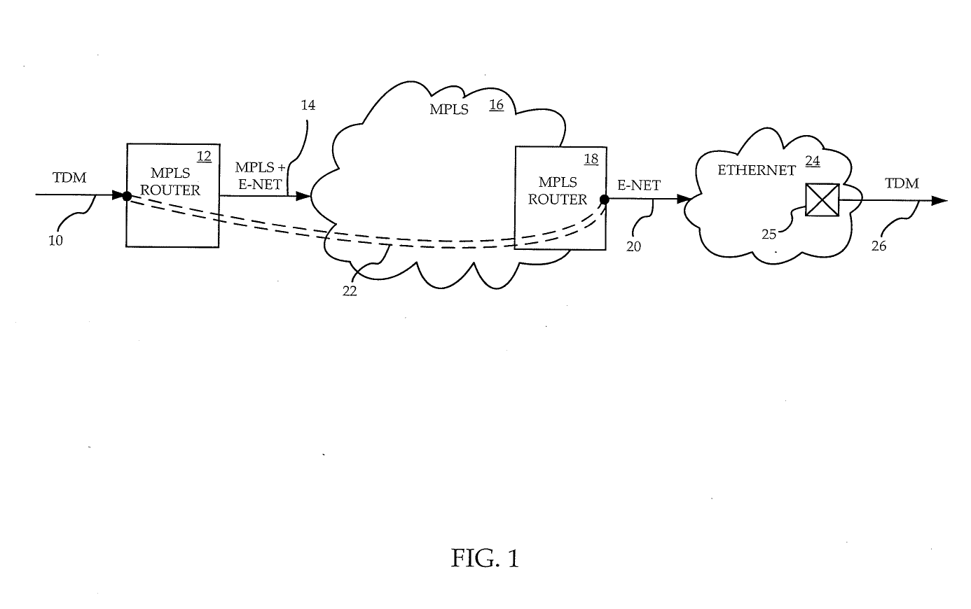

Referring to FIG. 1, a diagram of a network in which Circuit Emulation Service (CES) is provided is shown according to one embodiment of the invention. Incoming Time Division Multiplexed (TDM) data 10 on a TDM channel enters a first Multi-Protocol Label Switched (MPLS) router 12. The first MPLS router 12 first mimics a CES interworking function by packetizing the TDM data 10 and then by encapsulating the packetized TDM data into an Ethernet frame. The first MPLS router 12 then encapsulates the Ethernet frame into an MPLS packet, and then carries out Layer 2 encapsulation. The first MPLS router 12 transmits the MPLS- and Ethernet-encapsulated TDM data as a packet 14 into an MPLS core network 16.

The MPLS and Ethernet encapsulated packet 14 is routed through the MPLS core network 16 to a second MPLS router 18. The second MPLS router de-encapsulates the packet 14 by removing the Layer 2 encapsulation and the MPLS encapsulation, leaving an Ethernet frame 20. This effects an Ethernet pseudo-wire (PW) 22 between the ingress of the first MPLS router 12 and the egress of the second MPLS router 18. The second MPLS router 18 transmits the Ethernet frame 20 over an attachment circuit to a destination Ethernet 24. In this way, the second MPLS router 12 acts as described in Martini (ed.), “Encapsulation Methods for Transport of Ethernet over MPLS Networks”, RFC 4448, IETF, 2006, the contents of which are incorporated by reference herein.

Within the destination Ethernet network 24, the Ethernet frame is routed to a destination Ethernet switch 25, where the TDM data is extracted from the Ethernet packet 20 and transmitted as outgoing TDM data 26, as described in “MEF8: Implementation Agreement for the Emulation of PDH Circuits over Metro Ethernet Networks”, Metro Ethernet Forum, 2004.

Broadly, incoming TDM data is packetized, Ethernet encapsulated, and then MPLS encapsulated. The encapsulated packet is then sent through the MPLS core network to a destination Ethernet network through a destination MPLS router over an Ethernet pseudo-wire. At the destination MPLS router the MPLS encapsulation is removed. At the destination Ethernet network, the TDM data is extracted from the packetized and Ethernet-encapsulated TDM data, and transmitted onto a TDM channel.

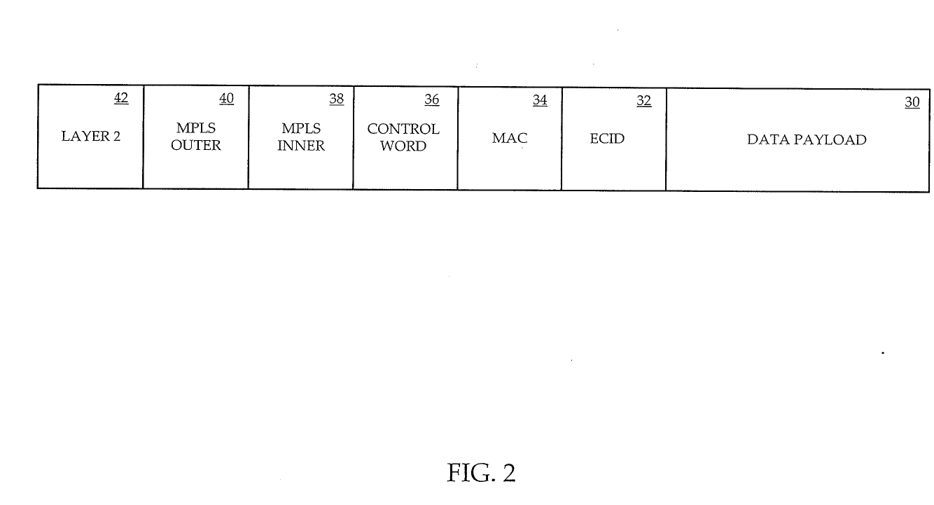

Referring to FIG. 2, a diagram of the format of the packet 14 generated and transmitted by the first MPLS router 12 according to one embodiment of the invention is shown. The packet 14 includes a data payload 30 in the form of the bits of the TDM data. The first MPLS router 12 performs Ethernet encapsulation by adding an Emulated Circuit Identifier (ECID) 32 and a destination Medium Access Control (MAC) address 34. The first MPLS router 12 then performs MPLS encapsulation by adding an inner MPLS label 38 and an outer MPLS label 40, and, and optionally a control word 36. Finally, the first MPLS router 12 performs Layer 2 encapsulation by adding Layer 2 information 42. The format of the packet 14 may include other header fields, but these are not important to an understanding of the invention.

The first MPLS router 12 populates the ECID 32 and the destination MAC address 34 based on values configured by an operator during creation of the emulated circuit. The first MPLS router 12 determines the inner MPLS label 38 based on the port within the second MPLS router 18 through which packets associated with the incoming TDM data 10 are to be sent. This can be set up by an operator statically configuring a binding between the Ethernet port on the second MPLS router 18 and the TDM channel. Alternatively it can be set up using Label Distribution Protocol (LDP) in which an operator configures an Internet Protocol address of the second MPLS router 18 together with a 32-bit VCID, and LDP signaling establishes the correlation between the VCID and the inner MPLS label 38.

The first MPLS router 12 determines the outer MPLS label 40 based on the peer router it is trying to reach for the traffic on the given TDM channel. The first MPLS router 12 will have been configured with a number of MPLS tunnels through which the destination peer router can be reached, in accordance with normal MPLS practice, and the first MPLS router 12 selects one of the tunnels and uses the associated label associated with that tunnel as the outer MPLS label 40.

Returning to FIG. 1, passage of TDM data in its various encapsulated forms through the network will now be explained. Upon entering the MPLS core network 16, the packet 14 is routed through the MPLS core network 16 to a second MPLS router 18 through a tunnel associated with the outer MPLS label 40. Upon reaching the second MPLS router 18, the packet 14 is conveyed to the port specified by the inner MPLS label 38, at which point the Ethernet frame 20 is extracted and sent over the port to the Ethernet network 24.

Within the Ethernet network 24, the Ethernet frame 20 is routed to the destination Ethernet switch 25 based on the destination MAC address 34. The destination Ethernet switch 25 determines to which particular CES interface and interworking function to send the Ethernet frame 20 using the ECID 32. The interworking function for the ECID 32 (and hence for the appropriate TDM channel) extracts the data payload 30, and transmits the data payload as outgoing TDM data 26 over the TDM channel.

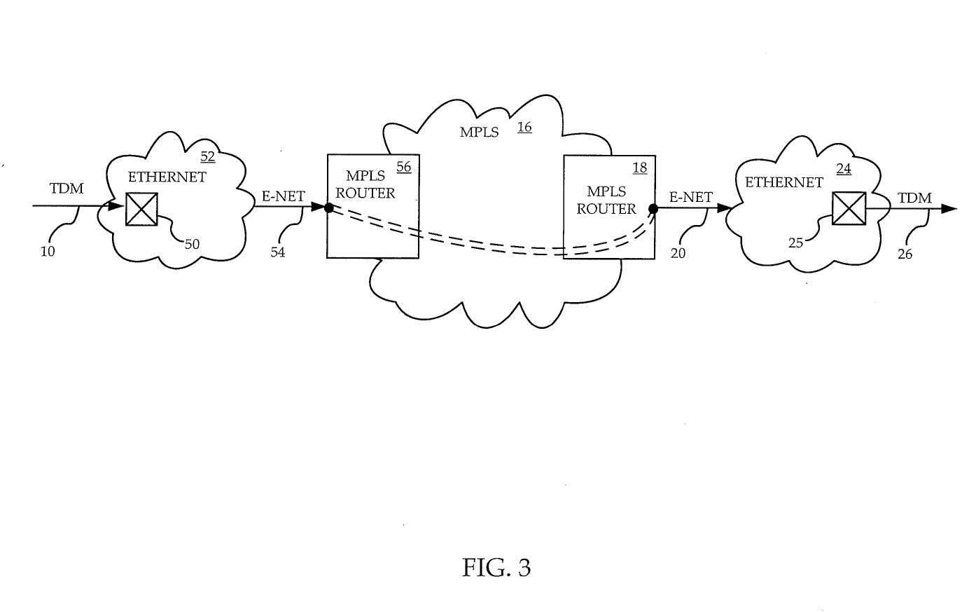

Referring to FIG. 3, a diagram of a network in which CES is provided according to another embodiment of the invention is shown. The network shown in FIG. 3 is similar to the network described above with reference to FIG. 1. However, part of the functionality of the first MPLS router 12 of FIG. 1 is carried out by a source Ethernet switch 50 in a source Ethernet network 52. Incoming TDM data 10 is received at the source Ethernet switch 50. An interworking function within the source Ethernet switch 50 packetizes the incoming TDM data 10 and performs Ethernet encapsulation as described above so as to generate an Ethernet frame 54. The Ethernet frame 54 is routed through the source Ethernet network 52 until it is forwarded to a source MPLS router 56. The source MPLS router 56 performs MPLS encapsulation on the Ethernet frame 54 so as to create an MPLS and Ethernet encapsulated packet as described above with reference to FIG. 2. The MPLS and Ethernet encapsulated packet is forwarded through the MPLS core network 16, and is thereafter processed as described above with reference to FIG. 1.

For TDM data traveling in the other direction, i.e. from right to left in FIG. 1, there may be more than one channel of TDM data arriving at the same Ethernet switch 25. In such a case, the second (now originating) MPLS router 18 may need to transmit Ethernet frames for different TDM channels along different pseudo-wires. One solution is for the second MPLS router 18 to use the VLAN ID of the Ethernet frame for a TDM channel to determine over which pseudo-wire to send the Ethernet frame. However VLAN IDs are limited in number in that there are only 4000 possible VLAN IDs. In addition, VLANs are typically configured manually. According to one aspect of the invention the second MPLS router 18 uses the ECID 32 of an Ethernet frame, assigned by the Ethernet switch 25, in order to determine which pseudo-wire to send the Ethernet frame. Since the ECID is a 20-bit number, many more pseudo-wires can be used than if the VLAN ID was used to define the pseudo-wire.

Use of the ECID 32 to define the pseudo-wire is also advantageous when the Ethernet and MPLS encapsulation is carried out on separate devices, as in the case of the embodiment described above with reference to FIG. 3. In such an embodiment, the source MPLS 56 router may use the ECID 32 to determine over which pseudo-wire to send the Ethernet frame 54. As yet another alternative, the ECID 32 may be used as the inner MPLS label 38 within an MPLS router that carries out both Ethernet encapsulation and MPLS encapsulation as described above with reference to the first MPLS router 12 of FIG. 1.

The invention is preferably implemented in hardware. The invention may alternatively be implemented as logical instructions in the form of software, or as a combination of software and hardware. If in the form of software, the logical instructions may be stored on a computer-readable medium.

The embodiments presented are exemplary only and persons skilled in the art would appreciate that variations to the embodiments described above may be made without departing from the spirit of the invention.

We claim:

1. A method of providing circuit emulation service (CES), comprising:
packetizing Time Division Multiplexed (TDM) data;
encapsulating the packetized TDM data with Ethernet encapsulation;
transmitting the packetized and Ethernet-encapsulated TDM data to a destination Ethernet network over an Ethernet pseudo-wire through a Multi-Protocol Label Switched (MPLS) network;
within the destination Ethernet network, extracting the TDM data from the packetized and encapsulated TDM data; and
transmitting the extracted TDM data onto a TDM channel.

2. The method of claim 1 wherein transmitting the packetized and Ethernet-encapsulated TDM data over an Ethernet pseudo-wire comprises:
encapsulating the packetized and Ethernet-encapsulated TDM data with MPLS encapsulation; and
conveying the packetized and Ethernet- and MPLS-encapsulated TDM data to a destination MPLS router through a tunnel defined by the MPLS encapsulation.

3. The method of claim 2 wherein encapsulating the packetized and Ethernet-encapsulated TDM data with MPLS encapsulation comprises adding an inner MPLS label, and wherein transmitting the packetized and Ethernet-encapsulated TDM data over an Ethernet pseudo-wire further comprises transmitting the packetized and Ethernet-encapsulated TDM data through an Ethernet port on the destination MPLS router, the Ethernet port being identifiable from the inner MPLS label.

4. The method of claim 2 wherein encapsulating the packetized TDM data with Ethernet encapsulation comprises adding an Emulated Circuit Identifier (ECID), and wherein transmitting the packetized and Ethernet-encapsulated TDM data over an Ethernet pseudo-wire further comprises transmitting the packetized and Ethernet-encapsulated TDM data over an Ethernet pseudo-wire being identifiable from the ECID.

5. The method of claim 2 wherein encapsulating the packetized TDM data with Ethernet encapsulation and encapsulating the packetized and Ethernet-encapsulated TDM data with MPLS encapsulation are carried out on a source MPLS router.

6. The method of claim 3 wherein encapsulating the packetized TDM data with Ethernet encapsulation and encapsulating the packetized and Ethernet-encapsulated TDM data with MPLS encapsulation are carried out on a source MPLS router.

7. The method of claim 3 wherein the inner MPLS label is configured by an operator so as to bind the Ethernet port on the second MPLS router 18 and the TDM channel.

8. The method of claim 3 wherein the inner MPLS label is determined using Label Distribution Protocol (LDP) in which an operator configures an Internet Protocol address of the destination MPLS router together with a 32-bit VCID, and LDP signaling establishes a correlation between the VCID and the inner MPLS label.

9. The method of claim 3 wherein encapsulating the packetized TDM data with Ethernet encapsulation comprises adding an Emulated Circuit Identifier (ECID), and wherein the inner MPLS label is set to the ECID.

10. The method of claim 6 wherein the inner MPLS label is configured by an operator so as to bind the Ethernet port on the second MPLS router 18 and the TDM channel.

11. The method of claim 6 wherein the inner MPLS label is determined using Label Distribution Protocol (LDP) in which an operator configures an Internet Protocol address of the destination MPLS router together with a 32-bit VCID, and LDP signaling establishes a correlation between the VCID and the inner MPLS label.

12. The method of claim 6 wherein encapsulating the packetized TDM data with Ethernet encapsulation comprises adding an Emulated Circuit Identifier (ECID), and wherein the inner MPLS label is set to the ECID.

13. A system for providing Circuit Emulation Service (CES), comprising:
a first Multi-Protocol Label Switched (MPLS) router for receiving Time Division Multiplexed (TDM) data, and adapted to packetize the TDM data, encapsulate the TDM data with Ethernet encapsulation and then with MPLS encapsulation, and transmit the packetized and Ethernet- and MPLS-encapsulated TDM data into an MPLS core network;
a second MPLS router for receiving the packetized and Ethernet- and MPLS-encapsulated TDM data, for transmitting the packetized and Ethernet- and MPLS-encapsulated TDM data to a destination port specified by the MPLS encapsulation, and for extracting an Ethernet frame containing the packetized TDM data from the packetized and Ethernet- and MPLS-encapsulated TDM data; and
an Ethernet switch for receiving the Ethernet frame containing the packetized TDM data, for extracting the TDM data, and for transmitting the TDM data to a TDM channel specified by the Ethernet encapsulation.

14. A method for preparing a packet for circuit emulation service (CES), comprising:
receiving TDM data;
packetizing the TDM data;
encapsulating the packetized TDM data with Ethernet encapsulation such that a destination Ethernet switch and destination TDM channel are specified; and
encapsulating the packetized and Ethernet encapsulated TDM data with Multi-Protocol Label Switched (MPLS) encapsulation such that a destination MPLS router and an Ethernet port on the destination MPLS router are specified.

15. The method of claim 14 wherein encapsulating the packetized and Ethernet encapsulated TDM data with MPLS encapsulation comprises adding an inner MPLS label specifying the Ethernet port.

16. The method of claim 15 wherein encapsulating the packetized TDM data with Ethernet encapsulation comprises adding an Emulated Circuit Identifier (ECID) specifying the destination TDM channel, and where the inner MPLS label is set to the value of the ECID.
